(19) United States
(12) Patent Application Publication
(10) Pub. No.: US 2016/0339813 A1
(43) Pub. Date: Nov. 24, 2016

(54) VEHICLE SEAT AND METHOD FOR ADJUSTING A LOADING POSITION

(71) Applicant: JOHNSON CONTROLS COMPONENTS GMBH & CO. KG, Kaiserslautern (DE)

(72) Inventors: Dirk Dubois, Hinterweidenthal (DE); Jürgen Naßhan, Kaiserslautern (DE)

(21) Appl. No.: 15/112,866

(22) PCT Filed: Jan. 20, 2015
(86) PCT No.: PCT/EP2015/050980

§ 371 Date: Jul. 20, 2016

(30) Foreign Application Priority Data
Jan. 20, 2014 (DE) 10 2014 200 940.5
May 15, 2014 (DE) 10 2014 209 167.5

(51) Int. Cl. B60N 2/30; B60N 2/06; B60N 2/02; B60N 2/44

(52) U.S. Cl. CPC B60N 2/3093; B60N 2/3045; B60N 2/3009; B60N 2/444; B60N 2/06; B60N 2/0224; B60N 2/0232

(57) ABSTRACT

The invention relates to a vehicle seat (1) comprising a seat part (2) and a backrest (3). Said vehicle seat comprises a rear fitting part (5) which is connected to the backrest and a front fitting part (4) which is connected to the seat part. The rear fitting part is coupled to the front fitting part.

### PRIOR ART

The present invention relates to a vehicle seat having a seating part and a backrest, wherein the vehicle seat has a rear fitting, which is connected to the backrest, and a front fitting, which is connected to the seating part, and to a method for adjusting a vehicle seat into a loading position.

Vehicle seats of this kind are already known from prior art motor vehicle seats, for example. To increase the volume available for loading the vehicle, there is a known practice of adjusting the vehicle seat into a loading position. The disadvantage with the known solutions is that a complex mechanism often has to be activated manually by a user and this involves a considerable risk of injury. In contrast, mechanisms of simpler construction use the available installation space poorly and increase the available loading volume only slightly.

### Prior Art

It was therefore the object of the present invention to provide a vehicle seat and a method for adjusting a vehicle seat into a loading position which eliminates the disadvantages of the prior art. In particular, the intention is to provide a vehicle seat, which allows easier access to the rear seat bench of a vehicle and, at the same time, is designed to be as compact as possible in terms of installation space.

This object is achieved by means of a vehicle seat having a seating part and a backrest, wherein the vehicle seat has a rear fitting, which is connected to the backrest, and a front fitting, which is connected to the seating part, wherein the rear fitting is coupled to the front fitting.

The statements made in relation to this subject matter of the present invention apply equally to the other subject matter of the present invention and vice versa. Advantageous embodiments and developments of the invention can be found in the dependent claims and in the description with reference to the drawings.

The present invention relates to a vehicle seat having a seating part and a backrest, wherein the vehicle seat has a rear fitting, which is connected to the backrest, and a front fitting, which is connected to the seating part. A vehicle seat of this kind is, for example, a motor vehicle seat, in particular a passenger seat and/or a rear seat. The seating part is generally upholstered, as is the backrest. In particular, the vehicle seat is provided in such a way as to be vertically and/or longitudinally adjustable. The backrest is furthermore preferably provided in such a way as to be pivotable over a predetermined angular range into a use position in order to allow a comfortable seat position for a user.

A person skilled in the art will understand that the use position is provided in such a way that a user can occupy the vehicle seat.

The vehicle seat according to the invention can then be adjusted from the use position into a loading position, in which there is more free volume available, particularly behind and/or above the seat, than in the use position.

The coupling of the rear fitting to the front fitting makes possible adjustment into the loading position in a simple manner. The coupling makes it possible to perform the adjustment both automatically and manually, thereby improving the convenience of operation of the vehicle seat according to the invention.

The coupling preferably allows longitudinal adjustment of the rear fitting relative to the front fitting and/or relative to the vehicle body.

The coupling preferably comprises a slotted guide and a pin guided therein. In particular, the front fitting has the slotted guide and the rear fitting has the pin. A person skilled in the art will understand that this can also be reversed.

According to another embodiment of the present invention, provision is made for the front fitting and the rear fitting to be moved one Inside the other in the loading position. In particular, provision is made in this case for the rear fitting, which is arranged behind the front fitting in the use position, to be arranged at lease partially, preferably completely, adjacent to the front fitting in the loading position. For this purpose, the front and rear fittings are arranged or mounted on the vehicle seat in a manner laterally offset relative to one another. By arranging them adjacent to one another, it is advantageously possible to save even more installation space in the loading position.

According to another embodiment of the present invention, provision is made for the front fitting and the rear fitting to be coupled or remain coupled to the vehicle floor and/or, in particular, to the rail system both in the loading position and in the use position.

The stability of the vehicle seat in the loading position is thereby increased in comparison with vehicle seats, the rear fitting of which is released from the rail system in the loading position. In particular, the rear fitting is attached permanently to the rail system, preferably to a top rail.

According to another embodiment of the present invention, prevision is made for the front and rear fittings to be configured in such a way that the distance between the front fitting and the rear fitting is shortened as the vehicle seat is transferred from the use position into the loading position.

According to another embodiment of the present invention, provision is made for the front fitting to have a retention element, e.g. in the form of a pawl or a snap lock, with the aid of which the rear fitting is fixed relative to the front fitting in the loading position.

The rear fitting is thereby advantageously prevented from accidentally leaving its position when the vehicle seat is in the loading position.

According to another embodiment of the present invention, provision is made for the slotted guide to be of adjustable length. It is thereby advantageously possible to determine, e.g. with the involvement of a vehicle passenger, how far the rear fitting can be moved forward in the loading position.

The vehicle seat preferably has a locking means. With the locking means, unintentional adjustment, in particular longitudinal adjustment, of the rear fitting is prevented. As a particularly preferred option, the locking means comprises a pin arranged in a fixed location relative to the rear fitting and a locking pawl arranged on the rear fitting. In particular, the locking pawl engages around the pin in the locked state. As a very particularly preferred option, the locking pawl is provided in such a way as to be pivotable about a third axis of rotation.

The backrest is preferably provided in such a way as to be pivotable about a first axis of rotation around the rear fitting, and/or the seating part is provided in such a way as to be pivotable about a second axis of rotation around the front fitting. The volume available in the loading position is thereby advantageously further increased. As a particularly preferred option, the second axis of rotation is provided on an end of the front fitting remote from the rear fitting.

The seating part is preferably connected positively and/or nonpositively to the rear fitting in the use position. As a particularly preferred option, the seating part rests on the rear fitting, in particular on a stop element arranged on the rear fitting. As a very particularly preferred option, the seating part is connected releasably to the rear fitting in the use position.

The seating part is preferably coupled to the rear fitting, in particular via a coupling element. As a particularly preferred option, the coupling element is arranged rotatably on the seating part and the rear fitting. As a very particularly preferred option, the coupling element is arranged on the seating part in such a way as no be longitudinally adjustable, in particular by means of a slotted guide. Here, longitudinal adjustment takes place, in particular, parallel to the longitudinal adjustment of the rear fitting relative to the seating part and/or the vehicle body. The coupling of the seating part to the rear fitting advantageously makes it possible for the seating part to be pivoted automatically about the second axis of rotation during an adjustment of the rear fitting into the loading position. As an alternative or in addition, the seating part is provided in such a way as to be pivotable independently of the rear fitting. A person skilled in the art will understand that the seating part is, in particular, only pivotable before the rear fitting has been adjusted in the direction of the seating part.

The vehicle seat is preferably provided in such a way as to be longitudinally and/or vertically adjustable relative to the vehicle body. As a particularly preferred option, the vehicle seat has a top rail that is longitudinally movable and preferably lockable on a bottom rail connected in a fixed manner to the vehicle body. As a very particularly preferred option, the front fitting is arranged in a fixed manner on the top rail and/or the rear fitting is arranged on the top rail in such a way as to be longitudinally adjustable relative to the latter.

A manual and/or automatic, in particular electric, pneumatic and/or hydraulic, drive, which is configured to adjust the vehicle seat into the loading position, is preferably provided.

The present invention furthermore relates to a method for adjusting a vehicle seat, in particular a vehicle seat according to the present invention, into the loading position, wherein the rear fitting is adjusted relative to the front fitting.

The statements made in relation to this subject matter of the present invention apply equally to the other subject matter of the present invention and vice versa.

The rear fitting is preferably adjusted longitudinally relative to the top rail, the vehicle body and/or the front fitting.

The backrest is preferably pivoted about the first axis of rotation. As a particularly preferred option, the backrest is pivoted forward, in the direction of the seating part, out of a substantially vertical position.

The seating part is preferably pivoted about a second axis of rotation. As a particularly preferred option, the seating part is pivoted simultaneously, in particular automatically, with the adjustment of the rear fitting. As a very particularly preferred option, the seating part is pivoted into a substantially vertical position.

It is thereby possible in a particularly advantageous way to affect simple adjustment into a loading position in which as large as possible a volume which can be used for loading is made available.

The rear fitting is preferably first of ail unlocked before the adjustment. As a particularly preferred option, the seating part is unlocked in addition or as an alternative.

Further details, features and advantages of the invention will become apparent from the drawings and from the following description of preferred embodiments with reference to the drawings. Here, the drawings merely show illustrative embodiments of the invention, which do not restrict the essential concept of the invention.

### BRIEF DESCRIPTION OF THE DRAWINGS

The inventions are explained below with reference to FIGS. 1-7. These explanations are merely illustrative and do not restrict the general concept of the invention. The explanations apply to all the subject matter of the present invention equally.

FIG. 1 shows an illustrative first embodiment of a vehicle seat according to the present invention.

FIG. 2 shows an illustrative second embodiment of a vehicle seat according to the present invention.

FIG. 3 shows an illustrative embodiment of the method for adjusting a vehicle seat according to the second embodiment into a loading position.

FIG. 4 shows an embodiment of the method for adjusting a vehicle seat according to the second embodiment into a loading position, in an intermediate position.

FIG. 5 shows an embodiment of the method for adjusting a vehicle seat according to the second embodiment into a loading position.

FIG. 6 shows an illustrative embodiment of the method for adjusting a vehicle seat according to the first embodiment into a loading position.

FIG. 7 shows an embodiment of the method for adjusting a vehicle seat according to the second embodiment into a loading position.

### EMBODIMENTS OF THE INVENTION

In the various figures, identical parts are in all cases provided with identical reference signs and they are therefore also generally named or mentioned only once in each case.

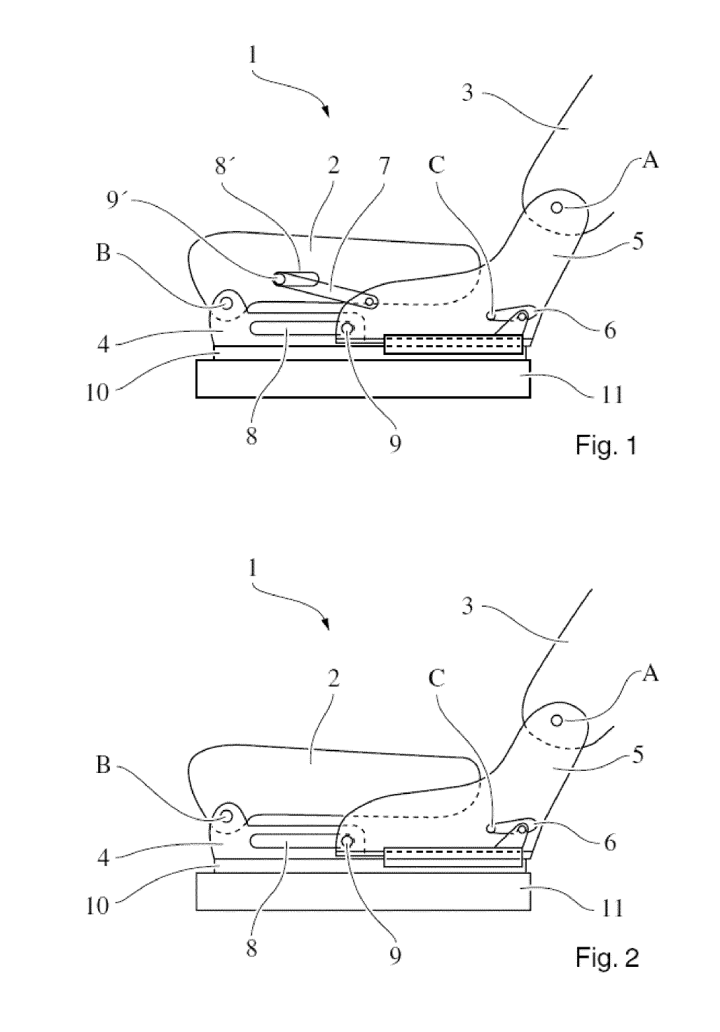

FIG. 1 shows an illustrative first embodiment of a vehicle seat 1 according to the present invention. The vehicle seat 1 has a seating part 2 and a backrest 3. The seating part 2 is arranged on a front fitting 4 in such a way as to be pivotable about a second axis of rotation B, and the backrest 3 is arranged on a rear fitting 5 in such a way as to be pivotable about a first axis of rotation A.

In a use position of the vehicle seat 3, the backrest 3 is arranged substantially vertically. In the use position, the backrest 3 is pivotable about the vertical position in an angular range of ±10°, for example. In the loading position, the backrest 3 is preferably pivoted forward in the direction of the seating part 2.

The vehicle seat 1 is arranged in such a way as to be longitudinally movable relative to the vehicle body. In this case, the longitudinal movement is accomplished by means of a rail system having a bottom rail, which is connected in a fixed manner to the vehicle body, and a top rail 11, which is supported movably and, in particular, lockable, by means of the bottom rail. A person skilled in the art will understand that such longitudinal movability is not essential. As an alternative, the top rail 11 can be connected in a fixed manner to the vehicle body.

The front fitting 4 is connected in a fixed manner to the top rail 11, while the rear fitting 5 is supported movably on the top rail 11. By means of a slotted guide 8 arranged on the front fitting 4, which guide interacts with a pin 9 arranged on the rear fitting 5, the rear fitting 5 is supported in such a way as to be longitudinally movable relative to the front fitting 4.

To prevent unintentional adjustment, a locking element 6 is provided. Here, the rear fitting 5 has a locking pawl, which is pivotable about a third axis of rotation C and which interacts with a pin arranged at a fixed location relative to the top rail 11. As long as the locking element 6 is in a locking position, the rear fitting 5 is supported in a fixed position relative to the front fitting 4.

In an unlocking position of the locking element 6, the roar fitting 5 can be moved longitudinally in the direction of the front fitting 4 and relative thereto.

Here, the seating part 2 merely rents on the rear fitting, e.g. on a stop element and/or a transverse strut. Alternatively, the seating part 2 can also be connected positively and/or nonpositively to the rear fitting 5, with the result that a relative movement of the rear fitting 5 is only possible when the seating part 2 and the locking element 6 are unlocked.

The seating part 2 is coupled to the rear fitting 5 by means of a coupling element 7, in this case a rod. In particular, the coupling element 1 is arranged rotatably on the seating part 2 and on the rear fitting 5.

Here, the seating part 2 additionally has a slotted guide 8′, which interacts with a pin 9′ of the coupling element 7, with the result that the coupling element 7 is supported rotatably and in a longitudinally movable manner on the seating part 2.

FIG. 2 shows an illustrative second embodiment of a vehicle seat 1 according to the present invention. In this case, the second embodiment corresponds substantially to the first embodiment described above. In contrast to the first embodiment, the vehicle seat 1 here has no coupling element 7.

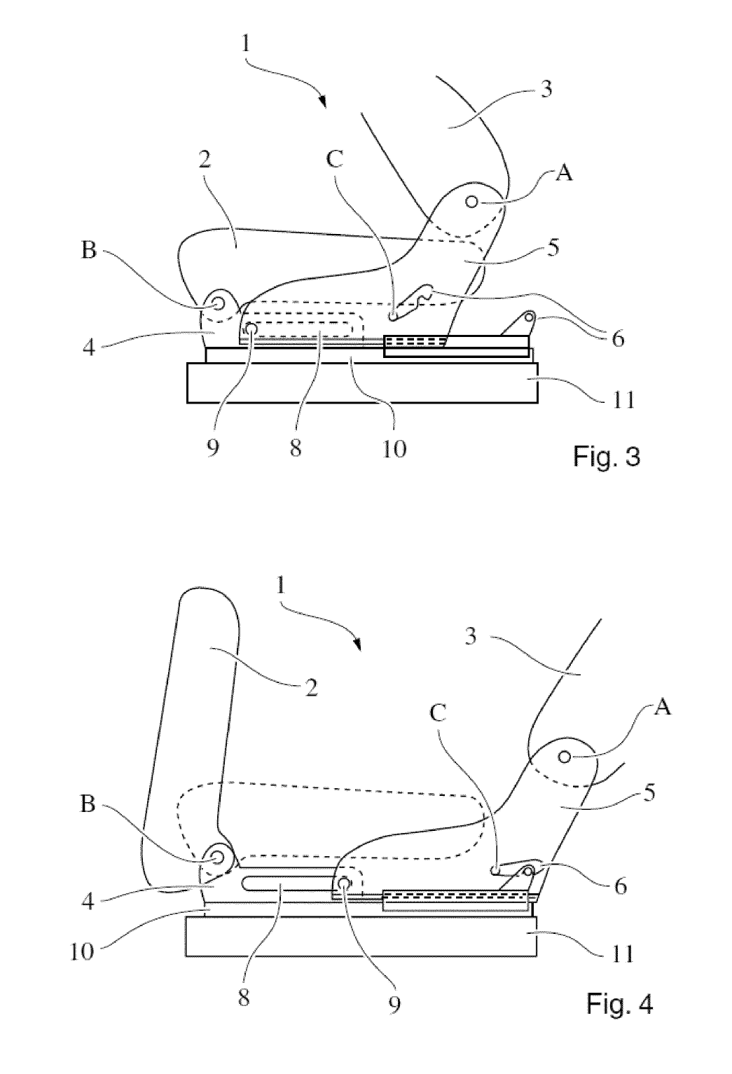

FIG. 3 shows an illustrative embodiment of the method for adjusting a vehicle seat 1 according to the second embodiment into a loading position. To adjust the vehicle seat 1 into a loading position, the locking element 6 is first of all unlocked here. The rear fitting 5 is then moved in the slotted guide 8 relative to the front fitting 4, and the backrest 3 is pivoted in the direction of the seating part 2, i.e. forward. Here, the pivoting of the backrest 3 can take place before, during or after the adjustment of the rear fitting 5 relative to the front fitting.

Here, the adjustment is brought about manually by a user. Alternatively or in addition, however, adjustment by means of a drive, e.g. an electric, pneumatic and/or hydraulic drive, is also possible. According to this embodiment of the method, the seating part is not moved during the adjustment, and therefore the backrest 3 is situated above the seating part 2 in the loading position.

FIG. 4 shows an embodiment of the method for adjusting a vehicle seat 1 according to the second embodiment into a loading position, in an intermediate position. This embodiment of the method according to the invention corresponds substantially to the embodiment described in connection with FIG. 3, although pivoting of the seating part 2 about the second axis of rotation B, in this case into a substantially vertical position, takes place first.

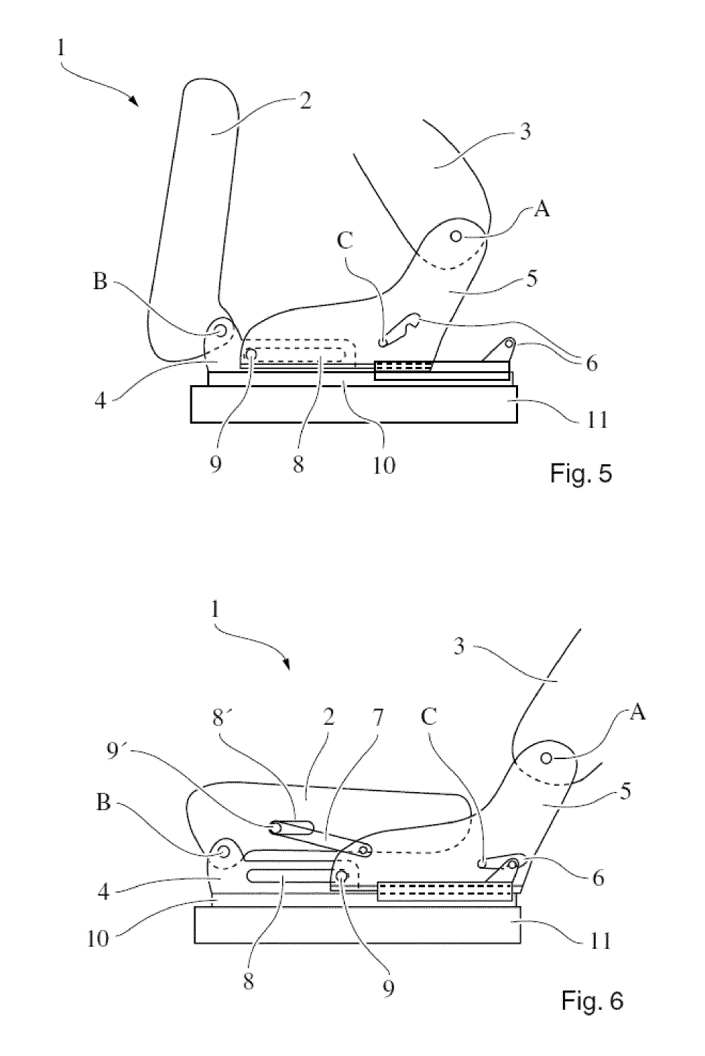

FIG. 5 shows an embodiment of the method for adjusting a vehicle seat 1 according to the second embodiment into a loading position. As described above, pivoting of the seating part 2 into a substantially vertical position as described in connection with figure 4 is followed by manual and/or automatic transfer of the locking element 6 into an unlocking position, pivoting of the backrest 3 about the first axis of rotation A and movement of the rear fitting 5 relative to the front fitting 4 in the direction of the seating part 2.

FIG. 6 shows an illustrative embodiment of the method for adjusting a vehicle seat 1 according to the first embodiment into a loading position. FIG. 6 corresponds substantially to FIG. 1. Attention is therefore drawn here to the statements relating thereto.

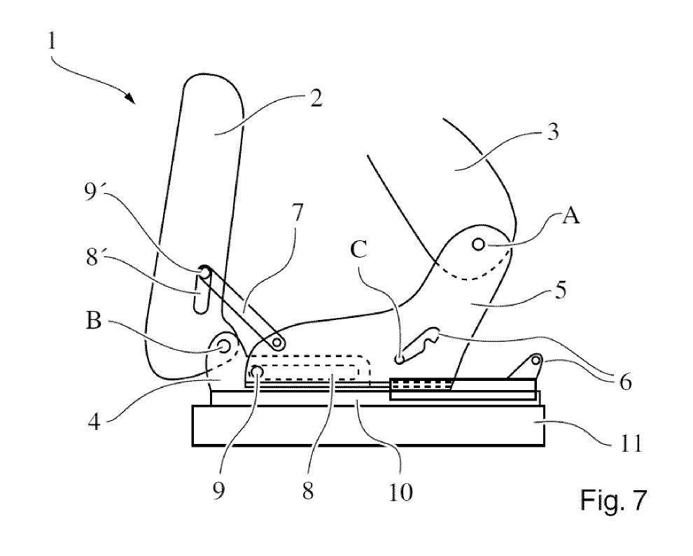

FIG. 7 shows an embodiment of the method for adjusting a vehicle seat according to the second embodiment into a loading position. Starting from the use position, as shown in FIG. 6, the locking element 6 is unlocked, i.e. pivoted about the third axis of rotation C, the backrest J is pivoted about the first axis of rotation A and the rear fitting 5 is moved toward the seating part 2 or the front fitting 4 relative to the front fitting 4 by way of the slotted guide 8 and the pin 9. By virtue of the coupling element 7, the movement of the rear fitting 3 automatically pivots the seating part 2 about the second axis of rotation B into a substantially vertical position. As a result, adjustment advantageously takes place automatically in a particularly simple manner. In this context, adjustment can take place manually and/or automatically, e.g. by means of an electric, pneumatic and/or hydraulic drive.

### LIST OF REFERENCE SIGNS

1 vehicle seal

2 seating part,

3 backrest

4 front fitting

5 rear fitting

6 locking element

7 coupling element

8, 8′ slotted guide

9, 9′ pin

10 top rail

11 body, bottom rail

A first axis of rotation

B second axis of rotation

C third axis of rotation

1. A vehicle seat having a seating part and a backrest, wherein the vehicle seat has a rear fitting, which is connected to the backrest, and a front fitting, which is connected to the seating part, wherein the rear fitting is coupled to the front fitting, wherein the coupling comprises a slotted guide and a pin guided in the slotted guide, wherein, the front fitting has the slotted guide and the rear fitting has the pin.

2. The vehicle seat as claimed in one of the preceding claim 1, wherein the vehicle seat has a locking means for preventing unintentional adjustment of the rear fitting.

3. The vehicle seat as claimed in claim 2, wherein the locking means has a pin arranged in a fixed location relative to the rear fitting and comprises a locking pawl arranged on the rear fitting, wherein the locking pawl engages around the pin in the locked state, and wherein the locking pawl is provided in such a way as to be pivotable about a third axis of rotation.

4. The vehicle seat as claimed in claim 1, wherein the backrest is provided in such a way as to be pivotable about a first axis of rotation around the rear fitting, and/or wherein the seating part is provided in such a way as to be pivotable about a second axis of rotation around the front fitting.

5. The vehicle seat as claimed in one claim 1, wherein the seating part is connected positively and/or nonpositively to the rear fitting in a use position.

6. The vehicle seat as claimed in claim 1, wherein the seating part rests on the rear fitting and wherein the seating part is connected releasably to the rear fitting in a use position.

7. The vehicle seat as claimed in claim 1, wherein the seating part is coupled to the rear fitting via a coupling element, wherein the coupling element is arranged rotatably on the seating part and the rear fitting and wherein the coupling element is arranged on the seating part in such a way as to be longitudinally adjustable.

8. The vehicle seat as claimed in claim 1, wherein the vehicle seat is designed to be longitudinally and/or vertically adjustable relative to the vehicle body, wherein the vehicle seat has a bottom rail and a top rail, wherein the bottom rail is connected in a fixed manner to the vehicle body and the top rail is arranged on the bottom rail in such a way as to be longitudinally movable and preferably lockable, wherein the front fitting is secured on the top rail and/or the rear fitting is secured on the top rail in such a way as to be longitudinally adjustable relative to the top rail.

9. The vehicle seat claimed in claim 1, wherein the vehicle seat has a manual and/or automatic drive, which is configured to adjust the vehicle seat into a loading position.

10. A method for adjusting the vehicle seat as claimed in claim 1 from a use position into a loading position, wherein a rear fitting connected to a backrest of the vehicle seat is adjusted relative to a front fitting connected to a seating part of the vehicle seat.

11. The method as claimed in claim 10, wherein the rear fitting is adjusted longitudinally relative to a top rail, the vehicle body and/or the front fitting.

12. The method as claimed in claim 10, wherein the backrest of the vehicle seat is pivoted about a first axis of rotation (A), and wherein the backrest is pivoted forward, in a direction of the seating part, out of a substantially vertical position.

13. The method as claimed in claim 10, wherein the seating part is pivoted about a second axis of rotation, and wherein the seating part is pivoted simultaneously with the adjustment of the rear fitting, and wherein the seating part is pivoted into a substantially vertical position.

14. The method as claimed in claim 10, wherein the rear fitting is first of all unlocked before the adjustment, and wherein the seating part is unlocked in addition or as an alternative.

15. The vehicle seat as claimed in claim 2, wherein the locking means are for preventing longitudinal adjustment of the rear fitting.

16. The vehicle seat as claimed in claim 6, wherein the seating part rests on a stop element arranged on the rear fitting.

17. The vehicle seat as claimed in claim 7, wherein the coupling element is arranged on the seating part to be longitudinally adjustable by means of a slotted guide.

18. The vehicle seat as claimed in claim 9, wherein the manual and/or automatic drive is an electric, pneumatic and/or hydraulic drive.

19. The method as claimed in claim 13, wherein the seating part is pivoted automatically with the adjustment of the rear fitting.
